(19) United States
(12) Patent Application Publication
(10) Pub. No.: US 2016/0178796 A1
(43) Pub. Date: Jun. 23, 2016

(54) DYNAMIC ANALYSIS OF DATA FOR EXPLORATION, MONITORING, AND MANAGEMENT OF NATURAL RESOURCES

(71) Applicant: Marc Lauren Abramowitz, Palo Alto, CA (US)

(72) Inventor: Marc Lauren Abramowitz, Palo Alto, CA (US)

(21) Appl. No.: 14/975,373

(22) Filed: Dec. 18, 2015

Related U.S. Application Data
(60) Provisional application No. 62/094,888, filed on Dec. 19, 2014.

(51) Int. Cl. G01V 99/00

(52) U.S. Cl. CPC G01V 99/00

(57) ABSTRACT

Methods, systems, devices and computer programs facilitate exploration and management of natural resources, such as natural gas and oil, using a plurality of data sources that are analyzed, filtered and reduced in real-time. Information related to a natural resource site is received that includes a particular production level or an operational capability of the natural resource site, a result of a previous exploration of a particular natural resource, or an identity of the natural resource site. Further information including weather, natural disasters, financial data related to natural resources, global political events, or legal data is obtained from a plurality of data sources. The information is then filtered to reduce the information based on identity of the natural resource site and a type of the request, and a customized data set is produced that is changeable in response to real-time changes in the information obtained from the plurality of data sources.

### CROSS REFERENCE TO RELATED APPLICATIONS

This patent application claims priority to U.S. Provisional Application No. 62/094,888, filed Dec. 19, 2014. The entire contents of the before-mentioned provisional patent application is incorporated by reference as part of the disclosure of this application.

### TECHNICAL FIELD

The present disclosure relates generally to systems, apparatuses, methods and computer programs that are stored on non-transitory storage media (collectively referred to as the “technology”) related to collecting and analyzing data that facilitates exploration and management of natural resources, such as oil and gas.

### BACKGROUND

Exploration of natural resources can be a costly venture. For instance, oil/gas exploration can start with finding visible surface features such as oil seeps, natural gas seeps, pockmarks (i.e., underwater craters caused by escaping gas) that provide basic evidence of hydrocarbon generation. However, most exploration depends on highly sophisticated technology to detect and determine the extent of these deposits using exploration geophysics. Areas thought to contain hydrocarbons can be initially subjected to scientific measurements and surveys, such as gravity surveys, magnetic survey, passive seismic or regional seismic reflection surveys to detect large-scale features of the sub-surface geology. Features of interest can be further subjected to more detailed surveys. When a prospect has been identified, evaluated and passes the oil/gas company's selection criteria, an exploration well is drilled in an attempt to conclusively determine the presence or absence of oil or gas. These operations are expensive and high-risk. Offshore and remote area exploration is generally only undertaken by very large corporations or national governments. Typical shallow shelf oil wells cost in the range of $10-30 million, while deep water wells can cost more than $100 million.

Even after a potential site passes the above selection criteria, many oil/gas sites fail to operate successfully and/or reliably due to a variety of known and unknown factors that include sub-optimum operations of the oil field equipment, human resource management and/or unanticipated geological issues. The majority of today's exploration wells for natural resources such as oil and gas are not successful in meeting their original objectives. Once operational, the extraction and proper flow of the natural resources may be interrupted to stopped due to a variety of foreseen and unforeseen factors. These issues may significantly increase the cost of finding and successfully harvesting the natural resource which, in turn, challenges a project's economic viability.

### SUMMARY OF CERTAIN EMBODIMENTS

Embodiments of the disclosed technology relate to methods, systems, devices and computer programs that facilitate exploration and management of natural resources, such as natural gas and oil, using a plurality of data sources that are analyzed, filtered and reduced in real-time.

One aspect of the disclosed technology relates to a method for facilitating exploration, management and monitoring of natural resources that includes receiving information related to a natural resource site, where the information includes one or more of: a particular production level of natural resource site, an operational capability of the natural resource site, a result of a previous test related to exploration of a particular natural resource, or an identity of the natural resource site, as well as a request from the natural resource site. The above noted method further includes obtaining information from a plurality of data sources comprising one or more of: weather, natural disasters, financial data related to natural resources, global political events, or legal data sources, and filtering the information obtained from the plurality of data sources to reduce the information obtained from the plurality of data sources based on at least the identity of the natural resource site and a type of the request to produce a customized data set. The method also includes producing a customized data set based on the reduced information. The customized data set is changeable in response to real-time changes in the information obtained from the plurality of data sources, and the customized data set facilitates exploration, management or monitoring of natural resources at the natural resource site.

### BRIEF DESCRIPTION OF THE DRAWINGS

FIG. 1 is a block diagram of a basic and suitable computer that may employ aspects of the described technology.

FIG. 2 is a block diagram illustrating a simple, yet suitable system in which aspects of the described technology may operate in a networked computer environment.

FIG. 3 is an exemplary diagram that shows interactions among a natural resource exploration/management (NREM) entity, a data aggregation and analysis system, a client, and a data source in accordance with an exemplary embodiment.

FIG. 4 illustrates the connectivity amongst different components of a system in accordance with an exemplary embodiment.

FIG. 5 illustrates various components of a data source and a data aggregation and analysis system in accordance with an exemplary embodiment.

FIG. 6 illustrates a data aggregation and analysis system and the associated interactions among its various components in accordance with an exemplary embodiment

FIG. 7 illustrates a block diagram of a device that can be implemented as part of the disclosed devices and systems.

FIG. 8 illustrates a set of exemplary operations that can be carried out to facilitate exploration and management of a natural resource in accordance with an exemplary embodiment.

### DETAILED DESCRIPTION

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

Development of new systems and methods that utilize real-time or near real-time data produced by a number of different sources can significantly improve the understanding and assessment of risks, and allow development of appropriate mitigating actions and strategies that improve exploration, monitoring and management of the natural resources and the associated operations.

Attempts to improve the operations of the oil field have improved some aspects of the oil field operation. These attempts are focused on monitoring the oil/gas field operations and equipment, and providing visualization tools that allows the oil field personnel to make appropriate decisions. For example, oil pressure in the pipes are monitored, oil field variations are measured, and other oil-field centric data is produced to assess the operational shortcomings and to allow for personnel to make the changes that are needed.

The exploration, management and operations of natural resources can be further improved through the use and customization of various additional data sources that not only relates to the particular natural resource site (e.g., the oil well or the oil field) or the close geographic vicinity of the resource site, but also to myriad other data sources that can directly or indirectly affect the operations, maintenance and efficiency of the natural resource exploration and extraction. This aggregate information is all-encompassing and includes numerous data sets so large and complex that it is difficult to analyze. Somewhere in this large collection of data, important information is buried, which cannot be effectively accessed and/or cannot be properly combined with or correlated with additional data to improve the accuracy and viability of natural resource exploration and operations.

One aspect of the disclosed technology relates to systems, apparatuses, methods and computer programs (e.g., that are stored on a computer readable medium) that enable the collection and analysis of data that improves exploration, monitoring, management and/or production of natural resources, such as oil and natural gas. The analyzed data can be used to generate risk assessments that is customized for a particular natural resource site. Such a risk assessment involves manipulation and transformation of data that is collected from, or based on, region-wide, country-wide, or world-wide events (and measurements).

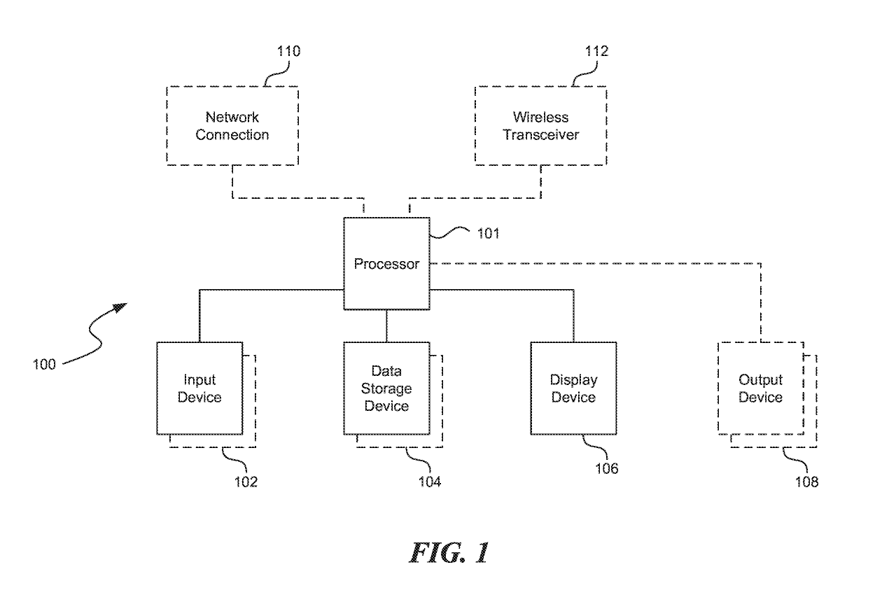

Referring to FIG. 1, an exemplary embodiment of the described technology employs a computer 100, such as a personal computer or workstation, having one or more processors 101 coupled to one or more user input devices 102 and data storage devices 104. The computer 100 can also be coupled to at least one output device such as a display device 106 and one or more optional additional output devices 108 (e.g., printer, plotter, speakers, tactile or olfactory output devices, etc.). The computer 100 may be coupled to external computers, such as via an optional network connection 110, a wireless transceiver 112, or other types of networks.

The input devices 102 may include a keyboard, a pointing device such as a mouse, and described technology for receiving human voice, touch, and/or sight (e.g., a microphone, a touch screen, and/or smart glasses). Other input devices 102 are possible, such as a joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet (not shown in FIG. 1). In some implementations, the device that is depicted in FIG. 1 is used as one device among a of a group of similar devices at operate at a facility tasked with natural resource exploration, monitoring or management.

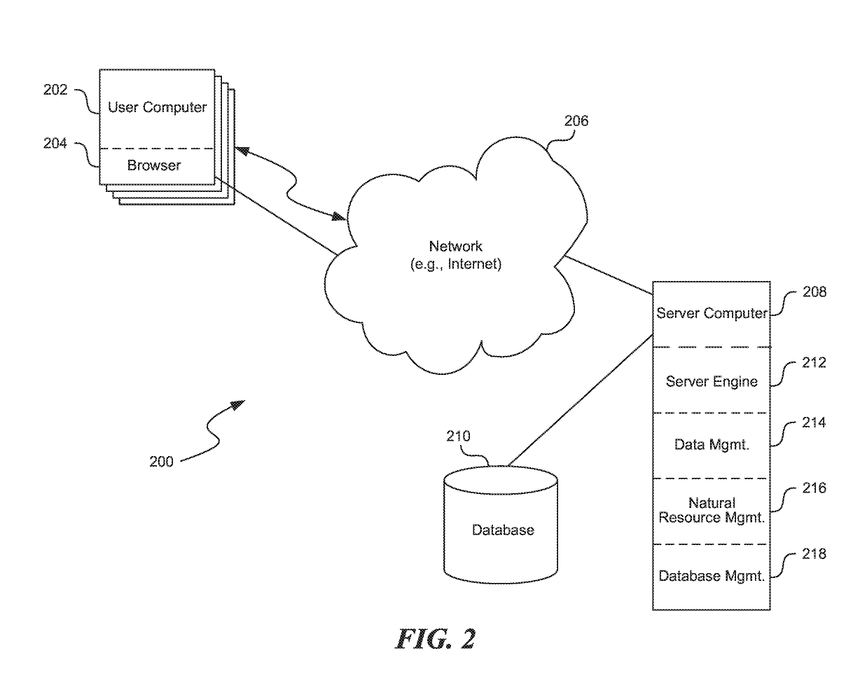

Aspects of the described technology may be practiced in a variety of other computing environments. For example, referring to FIG. 2, a distributed computing environment with a network interface includes one or more user computers 202 (e.g., mobile devices, desktops, servers, etc.) in a system 200, each of which can include a graphical user interface (GUI) program component (e.g., a thin client component) 204 that permits the user computer 202 to access and exchange data, with a network 206 such as a LAN or the Internet, including web sites, ftp sites, live feeds, and data repositories within a portion of the network 206. The user computers 202 may be substantially similar to the computer described above with respect to FIG. 1. The user computers 202 may be personal computers (PCs) or mobile devices, such as laptops, mobile phones, or tablets. The user computers 202 may connect to the network 206 wirelessly or through the use of a wired connection. Wireless connectivity may include any forms of wireless technology, such as a radio access technology used in wireless LANs or mobile standards such as 2G/3G/4G/LTE.

The user computers 202 may include other program components, such as a filter component, an operating system, one or more application programs (e.g., security applications, word processing applications, spreadsheet applications, processor-executable programs, or Internet-enabled applications), and the like. The user computers 202 may be general-purpose devices that can be programmed to run various types of applications, or they may be single-purpose devices optimized or limited to a particular function or class of functions. More importantly, any application program for providing a graphical user interface to users may be employed, as described in detail below. For example, a mobile application or “app,” such as one used in Apple's® iPhone® or iPad® products, Microsoft® products, Nokia® products, or Android®-based products. In some exemplary configuration of the system 200, the user computers 202 resides at an natural resource exploration or extraction facility, while in another exemplary configuration, the user computers 202 may be located site that is remote from, but in communication with, the natural resource exploration or extraction facility.

At least one server computer 208, coupled to the network 206, performs some or all of the functions for receiving, routing, and storing of electronic messages, such as weather-related data, data related to natural or other disasters, data related to prices of natural resources, data related to environmental laws and regulations, web pages, audio signals, electronic images, and/or other data. While the Internet is shown, a private network, such as an intranet, may be preferred in some applications. The network may have a client-server architecture, in which a computer is dedicated to serving other client computers, or it may have other architectures, such as a peer-to-peer, in which one or more computers serve simultaneously as servers and clients. A database or databases 210, coupled to the server computer(s), store some content (e.g., data related to prices of natural resources, data related to environmental laws and regulations, weather information, etc.) exchanged between the user computers; however, content may be stored in a flat or semi-structured file that is local to or remote of the server computer 208. The server computer(s), including the database(s), may employ security measures to inhibit malicious attacks on the system and to preserve the integrity of the messages and data stored therein (e.g., firewall systems, secure socket layers (SSL), password protection schemes, encryption, and the like).

The server computer 208 may include a server engine 212, a data management component 214, an natural resource management component 216, and a database management component 218. The server engine 212 can perform processing and operating system level tasks. The data management component(s) 214 handle creation, streaming, processing and/or routing of data related to prices of natural resources, data related to environmental laws and regulations, as well as other data, such as weather, natural or man-made disasters, and the like. Data management components 214, in various embodiments, includes other components and/or technology. Users may access the server computer 208 by means of a network path associated therewith. The natural resource management component 216 handles processes and technologies that support the collection, managing, and publishing of natural resource-related data and information, such as information that is provided in a customized fashion to a consumer of the system. The database management component 218 includes storage and retrieval tasks with respect to the database, queries to the database, and storage of data. In some embodiments, multiple server computers 208 each having one or more of the components 212-218 may be utilized. In general, the user computer 202 receives data input by the user and transmits such input data to the server computer 208. The server computer 208 then queries the database 210, retrieves requested pages, performs computations and/or provides output data back to the user computer 202. The data can be visually displayed to the user, can be in the form of audio alerts, or can cause automatic execution of computer programs that, for example, initiate mitigation actions. Additionally, or alternatively, the user computers 202 may automatically, and/or based on user computers' 202 settings/preferences, receive various information, such as alerts, updates, related to the any specified factors related to natural resource exploration, management or monitoring, from the server computer 208.

One aspect of the disclosed technology can be implemented as a system (e.g., a real-time system) that receives weather-related data, data related to natural or other disasters, data related to prices of natural resources, data related to environmental laws and regulations etc. from already-existing aggregators, in addition to individual users, and individual organizations. Such a system can then provide risk assessment related to natural resources to oil, gas and other companies that are involved in exploration or management of natural resources. Such a system can provide vastly improved performances that would have been unsatisfactorily conducted in-part by oil/gas companies or their affiliates, the operations that would have been performed unsatisfactorily by big data providers, while providing many unique features that cannot be provided by conventional systems. Most of the currently available data related to natural resources pertains to local natural resource site, that can be vastly improved to allow the operation of a particular exploration/extraction site to be in-line with global changes, and with factors beyond the locality of the natural resource site. The disclosed technology provides various filters that can effectively filter out the noise, and directly produce relevant data that enables the production of a customized solution based on rapidly changing (e.g., real-time or semi-real-time) weather-related data, data related to natural or other disasters, data related to prices of natural resources, data related to environmental laws and regulations, and other factors, as well as local data that relates to a particular natural resource site.

In some implementation, the system can further provide a list of options to an natural resource exploration entity as to which types of data/conditions to track for an individual natural resource site (or group of sites). In some embodiments, the natural resource exploration/management company can select items of interest, and change those items iteratively as the needs of the company change. In some embodiments, a particular natural resource facility can be notified and provided with recommended actions that are based on the real-time assessments (e.g., a terrorist attack in Canada has interrupted the production of Canadian oil, which is likely to require an increased oil production level at your site immediately).

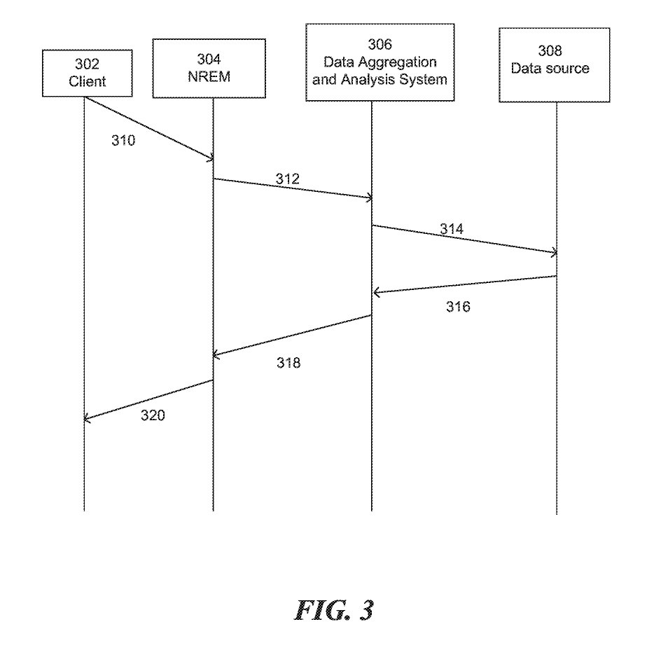

FIG. 3 is an exemplary diagram that shows interactions among a natural resource exploration/management (NREM) entity 304, a data aggregation and analysis system 306, a client 302, and a data source 308, in accordance with an exemplary embodiment. The client can, for example, be a specific oil exploration site, such as an offshore oil rig. At 310, a client 302 initiates a particular request to the NREM 304, such as inquiring about the chances of finding increasing oil at a particular site, the likelihood of requiring an increased production in the next 48 hours, and the like. The client 302 can provide some information to the NERM 304, as well, such as their current production output, the results of a previous test that was conducted to determine the viability of a particular site, and the like. At 312, based on the provided information from the client 302, the NREM 304 requests related data from a data aggregation and analysis system 306. The data aggregation and analysis system 306 may store, or have ready access to, the requested information and therefore can provide such information readily to the NREM 304. The data aggregation and analysis system 306 uses, at least in-part, the identification information provided by the client 302 to find data related to the client 302. As will be further described in the sections that follow, the data aggregation and analysis system 306 can use data provided by other users or organizations, and/or data that is collected by other sources to produce the relevant information for the NREM 304.

Referring again to FIG. 3, at 314, the data aggregation and analysis system 306 further collects data from the data source 308, before providing the needed data to the NREM 304. At 316, the data source 308 provides the requested data to the data aggregation and analysis system 306. The transmission of such data from the data source 308 to the data aggregation and analysis system 306 is through a network, and may take place multiple times, even though only one connection 316 is shown in FIG. 3. The data transferred from the data source 308 to the data aggregation and analysis system 306 may contain images, video, text, or other types of information. In one example, such data is in a pre-defined format, or may be other loosely defined collection of data. At 318, the data aggregation and analysis system 306 provides a decision or feedback to the NREM 304, based on the data obtained from the data source 308, the information provided by the NREM 304, or the data provided by the client 302. In another example, such decision may be made by the NREM 304, and the data aggregation and analysis system 306 may only provide the refined data or feedback that is needed to make such a decision. For instance, the feedback provided at 318 may be processed, filtered, and organized information based on raw data collected at 316.

At 320, the NREM 304 provides a result to the client 302. The result provided at 320 may be an indication that requested by the client 302 at 310. It should be noted that while the communications between the different entities in FIG. 3 are illustrated using a single, one-directional arrow, in some embodiments, each such communication may include more than one communication (back and forth) between the depicted entities. For example, the NREM 304 may request, and receive, additional information from the client 302; the data aggregation and analysis system 306 may request, and receive, additional information from the NREM 304, and so on.

In one implementation, the operations performed by the NREM 304, the data aggregation and analysis system 306, and the data source 308 are carried out on different computers, systems, or platforms.

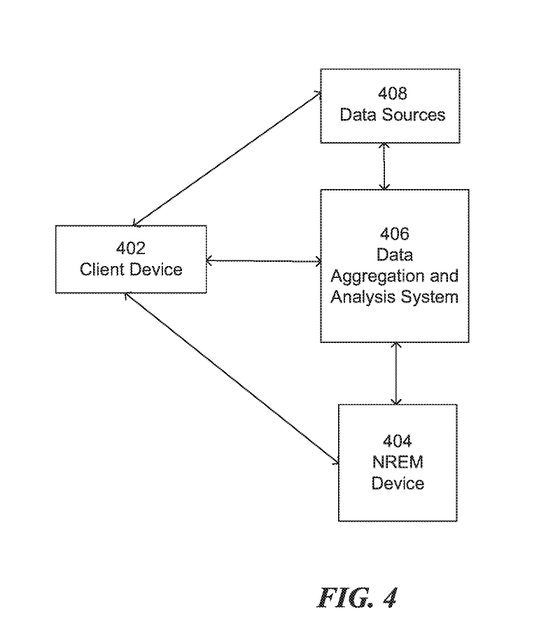

FIG. 4 illustrates the connectivity amongst different components of the system in accordance with an exemplary embodiment. The NREM device 404 is coupled to the data aggregation and analysis system 406 to send and receive various information, data and commands, as, for example, illustrated in FIG. 3. The NREM device 404 is also coupled to the user device 402 to communicate send and receive various information, including requests, operational data, and other information, as, for example, discussed in connection with FIG. 3.

The client device 402 or the NREM device 404 may be implemented using a hardware architecture that is described, for example, in connection with FIG. 1. For instance, the client device 402 can be a personal device (e.g., a laptop, a tablet, as smart phone, etc.) of a particular user that allows the provision of various information to the NREM device 404. In another implementation, the client device 402 can be computer system of an organization and can provide the NREM device 404 organizational identification information. The request by the client device 402 can be for obtaining data and/or instructions that facilitates management, monitoring or exploration of natural resources. The request by client 402 may be changeable at a certain time. In some implementations, a particular request may not be necessary. For example, the user may have subscribed to a service that automatically provides notifications to the user upon occurrence of certain events.

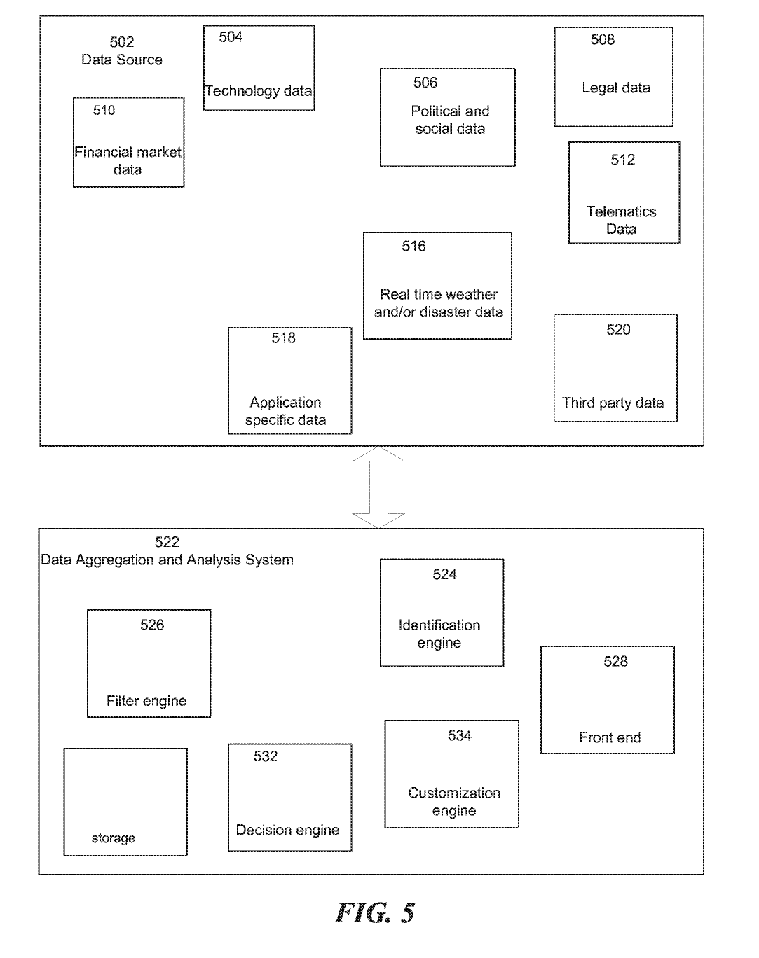

The data source(s) 408, which will be described in further detail in FIG. 5, comprise computer device and/or storage devices that produce, retain, and/or obtain a variety of data. In one implementation, the data source 408 also includes data provided by an individual user, such as a user using the client device 402.

As will be detailed in connection with FIG. 5, in one implementation, the data aggregation and analysis system 406 includes various component such as a front end, an identification engine, a customization engine, a filter engine, a storage, and a decision engine. In one exemplary embodiment, the hardware architecture of the data aggregation and analysis system 406 is similar to those illustrated in FIG. 2 in connection with the computer server 208 and the associated components such as the server engine 212, data management 214 component, natural resource management 216 component, and database management component 218.

One set of exemplary interactions among the various components of FIG. 4 were previously described in connection with FIG. 3. It is, however, understood that the interactions among the NREM device 404, the data aggregation and analysis system 406, the client device 402, and the data source 408, can be more complex than the sequence diagram shown in FIG. 3. For example, the client device 402 may directly interact with the data aggregation and analysis system 406. The data aggregation and analysis system 406 may periodically collect data from the client device 402 directly without going through the NREM device 404 or the data source 408. In one implementation, the data aggregation and analysis system 406 can provide a customized set of data that is produced by analyzing the information that it receives from a plurality of data sources, and use a modeling and simulation techniques to make predications and provide risk assessments.

As will be clarified further in the sections that follow, the system that is described in FIG. 4 provides many advantages and features by obtaining data from a multitude of data sources, requesting customized information, providing filtering operations, and iteratively fulfilling the needs of the client device 402 and the NREM device 404.

As illustrated in FIG. 5, the data source 502 can include a financial market data source 510, a technology data source 504, a political and social data source 506, a legal data source 508, a telematics data source 512, a real time weather and disaster data source 516, an application specific data source 518, and any third party data source 520. In some implementations, data sources such as the political and social data source 506, the legal data source 508, the telematics data source 512, the real time weather and disaster data source 516, and the application specific data source 518 identify a location of the nature resource explicitly, such as by GPS coordinates, a geographical landmark, a city/county or any other names. In some instances, the data may not be location specific, such as the financial market data source 510 and the technology data source 504.

The financial market data source 510 includes stock market information from various countries. In one exemplary implementation, the financial market data includes data from financial securities, commodities, money markets, derivative markets, future markets, insurance markets, foreign exchange and other fungible items of value such as energy market. Securities include stocks and bonds, and commodities include precious metals or agricultural goods. The financial market data source 510 includes data from various locations such as physical location (like the NYSE, BSE, NSE) or an electronic system (like NASDAQ).

The financial market data can be useful for natural resource management, exploration, transportation decisions because such activities require large amount of capitals. The fluctuation of the financial market can help to decide the natural resource management, exploration, transportation decisions. For example, when the stock market is low, and it is easy to gain capital, the natural resource management may decide to obtain more money to explore more wells for oil or gas. On the other hand, if there is a shortage of energy supply, the nature resource production should increase, while the contrary may be true when there is an extra supply of the energy supply. Further, fluctuations in financial data related to a natural resource may be due of hidden factors (e.g., secrets, insider trading, etc.) that are likely to affect management, exploration, transportation or monitoring of natural resources—such hidden factors may not be publically available but may be implied in financial data fluctuations.

The technology data source 504 can include patents, research discoveries on various technologies such as chemistry, material science, computer science and engineering, mechanical, geology, and so on. New material development may make new equipment possible, while new equipment can make extraction and utilization of previously-infeasible natural resources feasible. The technology data source 504 can include any publication resources such as journals, magazines, any patent publications, any new product announcements. Such technology data can help with management of natural resources by anticipating and predicting the possible productions and the capabilities of competitors in near-term or near future.

The political and social data source 506 can include any new laws passed by the congress or other government which may have an impact in the nature resources. Government often participates in the regulation of natural resources for environmental or energy conversation reasons. Such government policies can impact natural resource management in certain ways. Similar social data such as any social unrest in a particular region of the world can cause shortage of skilled labor, supply of the natural resource, exploration of the resource or its transportation. The political and social data source can be coupled to news sources, such as websites, radio station, TV stations, messages, etc.

The legal data source 508 can include court records and rulings. Any potential law suit or current law suit can have an impact on the natural resource management. For example, an adverse ruling against a particular company that is involved in exploration of natural resources can drain the financial resources, and impact the company's short-term and long-term decisions. Related court rulings can have impacts similar to congress policies.

The telematics data source 512 includes data generated by telematics methods. Telematics is an interdisciplinary field encompassing telecommunications, vehicular technologies, road transportation, road safety, electrical engineering (sensors, instrumentation, wireless communications, etc.), computer science (multimedia, Internet, etc.). Telematics data source 512 can include sensors implanted to monitor certain factors that can affect the natural resource production, exploration or management. The sensors can, for example, send feedback information to computer system to monitor the field of the natural resource. Such information can be used for maintenance, prevention, or prediction of possible future disasters in the nature resource field.

The real time weather and/or disaster data source 516 can provide data obtained from agencies that monitor or forecast weather patterns or disasters. Such disasters can include natural disasters, such as earthquakes, volcano eruptions, solar flares, etc., and man-made disasters, such as nuclear plant meltdowns, outbreak of a war, oil and natural gas accidents, etc. Such data can be used to predict the near or distant future risks and is often associated with a geographic location or region.

The third party data source 520 includes data provided by other data aggregators or data providers, which may include raw data, or data that is processed in some way. As noted earlier, such third party data sources 520 often produce large amounts of data that includes duplicative and irrelevant information. The disclosed technology utilizes such third party data sources 520 as one of many sources of data, while providing effective filtering and processing operations that enables the discovery of the proverbial needle in the haystack. To this end, the third party data can be augmented with specific data that is customized to be received by disclosed system, and the collective data sources are processed to produce information related to a specific nature resource location on a real-time basis.

The application specific data source 518 is generated by the data aggregation and analysis system to fulfill a specific need of a particular location of nature resources. For example, the application specific data source 518 can be generated by the data aggregation and analysis system 522 in response to a specific request by a nature resource company. The application specific data source 518 can be updated based on new data received from other data sources, revisions to the requests received from the nature resource company, or both.

FIG. 5 further illustrates various component of a data aggregation and analysis system 522 that includes a front end 528, an identification engine 524, a customization engine 534, a filter engine 526, a storage 530, and a decision engine 532. In one implementation, the components that are described as part of data aggregation and analysis system 522 are implemented at least partially in hardware including electronic circuits, such as implementations via an ASIC, FPGA, or a digital signal processor (DSP).

The front end 528 receives input from, and provide output to, other components such as a client device or a data source. For example, the front end 528 can directly accept input from a client. In one implementation, the front end 528 contains an interface, such as a GUI, to help the users to input data and display data to the users. The GUI can, for example, be displayed on a web browser running on a computer or a microprocessor. In some implementations, the front end 528 can receive input simultaneously from multiple devices, such as a client device, a NREM device, and from one or more data sources.

The identification engine 524 identifies the client. For example, a client may provide one name to the system. In this example, the identification engine 524 uses various data sources to check for different names related to the client. Sometimes a weather data may be identified by a larger area name, and covers the name provided by the client. The identification engine 524 resolves the difference in various ways to identify the client.

The customization engine 534 is activated in response to NREM's or user's request for a specific type of data that may not currently exist in the data aggregation and analysis system 522. In such a scenario, the data aggregation and analysis system 522 provides a communication mechanism so that the NREM device can request a particular customized data to be generated by the data aggregation and analysis system 522. For example, an NREM device can request a customized risk assessment for a particular oil well in West Africa. In this example, the customization engine 534 creates an application specific data source that receives information from the weather and/or disaster data source 516, telematics data source 512 or other data sources. The customization engine 534 then utilizes filters (e.g., as part of the customization engine 534 or the filter engine 526) to filter out the relevant information. Thus, the customization engine 534 can process data provided by a NREM, a client or a data source, and produce customized information. It should be noted that the application specific data source 518 can collect data via connections to the other data sources that are illustrated in FIG. 5, and/or the system can set up a connection to a different data source (not listed) that may be needed to acquire the application specific data.

The filter engine 526 is used to analyze data received from various data sources, such as the ones depicted as part of data source 502. There may be many conflicting data, out of date data, which will be removed by the data filter engine 526. In one implementation, the filter engine 526 organizes the results in a coherent and consistent fashion, such as data that is sorted by time or by relevance. In one implementation, the filter engine 526 organizes the data based on the client identification; the identity of the client may be authenticated or verified by the identification engine 524.

The storage 530 is used to store the filtered data from filter engine 526, so that it can be used for future purposes. The storage 530 can be a memory device (e.g., RAM, ROM, etc.), a hard disk, a flash drive, and so on. The storage 530 can be used to store any data received from the front end 528, or any other components of the data aggregation and analysis system 522, as well as computer program codes that may be retrieved and executed by a processor to perform the various disclosed operations.

The decision engine 532 includes decision logic for computations that lead to a decision based on the filtered data produced by the filter engine 526. In one implementation, the decision engine 532 includes an algorithm that implements a predetermined risk model such as statistics-based model. In some embodiments, the metric also includes information as to the particular statistics-based model that was used to produce the risk assessments, and any assumptions that may have been made in producing the risk assessments.

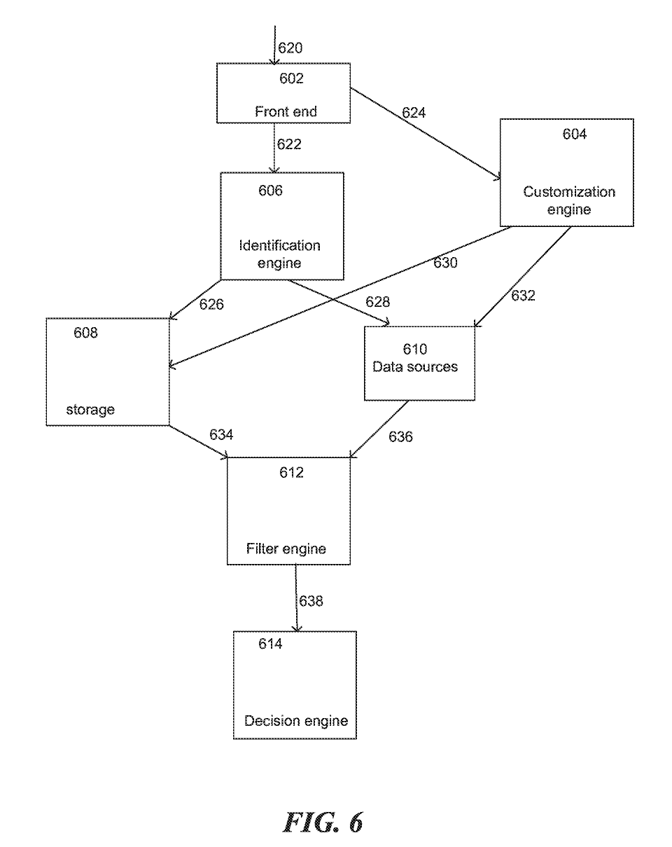

FIG. 6 illustrates a data aggregation and analysis system and the associated interactions among its various components in accordance with an exemplary embodiment. At 620, an input is received at the front end 602. The input may be a request for data from a user device or from a NREM device, a data from a data source, or from a client. In one implementation, the input to the front end 602 is accepted through a GUI interface. In some implementations, the input to the front end 602 is accepted from another computer through a computer-to-computer communication link. The front end 622 processes the received data. For example, the processing can include parsing the received data to extract identification information. At 622, at least part of the data processed by the front end 622 that includes one or more forms of identification information is provided to the front end 602. In one implementation, the identification information includes one or more of a name, a current location identifying the client.

The data that is received by the front end 602 can include particular requests. At 604, such requests are provided to the customization engine 604 to generate the new data (e.g., data templates, date sources, etc.) which is not currently established in the data aggregation and analysis system. The customization may be done on the data collected.

At 626 and 630, the customized request, the client identification information, or the customized data may be sent to the storage 608 to be stored in the data aggregation and analysis system. If the requested data is not in the storage, the data aggregation and analysis system may, at 628, send out a request to the data sources 610 to gather more data.

At 634 and 636, after all the data is gathered from the storage 608 or from data sources 610, the data is passed to the filter engine 612 to be analyzed. In one implementation, there are many conflicting data, out of date data, duplicate data, or irrelevant data which are removed by the data filter engine 612. In one implementation, the filter engine 612 also organizes the results to produce a coherent and consistent data that is sorted in a predetermined order, such as based on time or by relevance. For example, sorting by relevance can produce ordered entries that are sorted based on their relevance to the requested data, or relevance to the individual client. Sorting by time can produce entries that are, for example, listed in the descending order of occurrence, with the most recent data being listed first and the oldest data being listed last. At 638, the filtered and organized data is provided to the decision engine 614 which makes a decision based on the filtered data. As noted earlier, the decision engine 614 can implement a predetermined risk model, such as statistics-based model.

The interactions among the various components shown in FIG. 6 are only for illustration purposes and are not limiting. For example, there may be other additional interactions that are not shown. Furthermore, the communications between different components are shown as one-sided arrows. It is understood, however, that bidirectional communications can take place among the various components.

The components or modules of the disclosed systems can be implemented as hardware, software, or combinations thereof. For example, a hardware implementation can include discrete analog and/or digital circuits that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

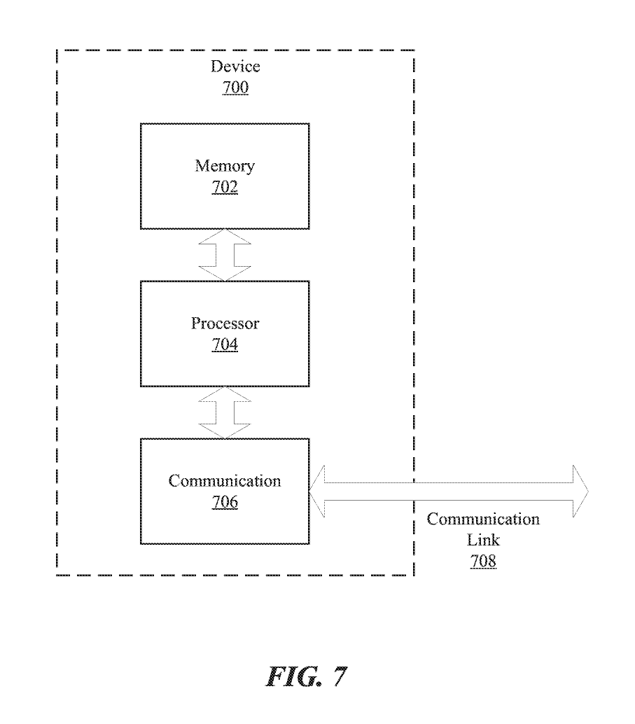

FIG. 7 illustrates a block diagram of a device 700 that can be implemented as part of the disclosed devices and systems. The device 700 comprises at least one processor 704 and/or controller, at least one memory 702 unit that is in communication with the processor 704, and at least one communication unit 706 that enables the exchange of data and information, directly or indirectly, through the communication link 708 with other entities, devices, databases and networks. The communication unit 706 may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The exemplary device 700 of FIG. 7 may be integrated as part of the devices or components of the disclosed technology, such as the user device, the natural resource exploration/management (NREM) device (e.g., a device that is used by an NREM entity to carry out some or part of operations pertaining to exploration, management or monitoring of natural resources), the data sources, or the data aggregation and analysis system.

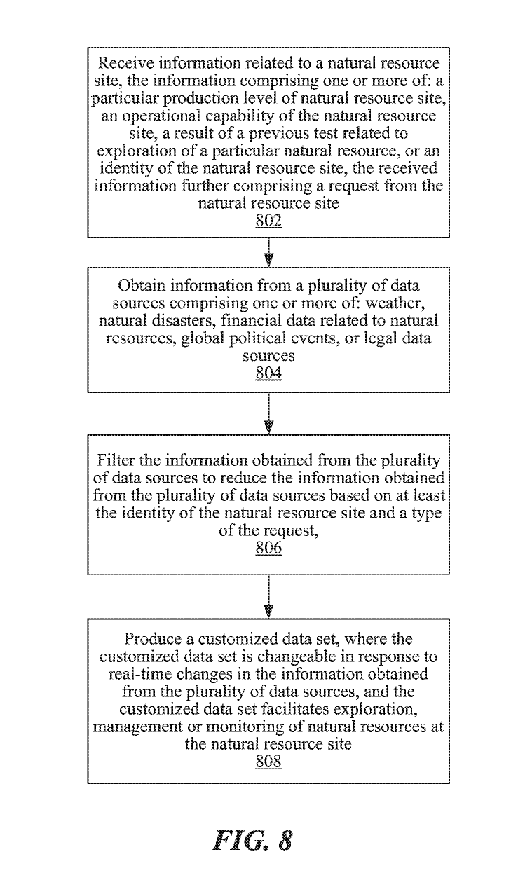

FIG. 8 illustrates a set of operations that can be carried out for exploration and management of natural resources in accordance with an exemplary embodiment. At 802, information related to a natural resource site is received. The information includes one or more of: a particular production level of natural resource site, an operational capability of the natural resource site, a result of a previous test related to exploration of a particular natural resource, or an identity of the natural resource site, the received information further comprising a request by the natural resource site. At 804, information from a plurality of data sources is obtained. The data source includes one or more of: weather, natural disasters, financial data related to natural resources, global political events, or legal data sources. At 806, the information obtained from the plurality of data sources is filtered to reduce the information obtained from the plurality of data sources based on at least the identity of the natural resource site and a type of the request. At 808, a customized data set is produced. The customized data set is changeable in response to real-time changes in the information obtained from the plurality of data sources, and the customized data set facilitates exploration, management or monitoring of natural resources at the natural resource site.

In one exemplary embodiment, at least one of the data sources includes information related to a geographic location that is different from the geographic location of the natural resource site. In another exemplary embodiment, the geographic location that is different from the geographic location of the natural resource site is located in a different continent than the geographic location of the natural resource site. According to another exemplary embodiment, the customized data set includes information related to a pending or a recently-occurred natural disaster that is likely to affect exploration, management or monitoring of natural resources at the natural resource site. In yet another exemplary embodiment, the customized data set includes information related to a pending or a recently-occurred political or social event that is likely to affect exploration, management or monitoring of natural resources at the natural resource site.

In another exemplary embodiment, the customized data set includes information related to a legal event that is likely to affect exploration, management or monitoring of natural resources at the natural resource site. In one exemplary embodiment, the legal event is one or more of: a conclusion of a legal court proceeding related to a natural resource, a treaty related to a natural resource, a law related to a natural resource, or a regulation related to an environmental regulation of a natural resource. In another exemplary embodiment, the customized data set includes information related to a price fluctuation of a natural resource. In yet another exemplary embodiment, the customized data set includes information related to an operational capability at the natural resource site. In still another exemplary embodiment, the natural resource site is an oil or a natural gas site. In another exemplary embodiment, the request from the natural resource site includes one or more of the following: an inquiry regarding a likelihood of finding additional oil at a particular site, or an inquiry regarding a likelihood of requiring an increased production of oil in a particular future interval of time.

Another aspect of the disclosed technology relates a system that facilitates exploration and management of natural sources that includes a data aggregation and analysis component implemented at least partially using electronic circuits, and including an identification engine, a filter engine, a decision engine and a non-transitory computer readable storage. Such system further includes a plurality of data sources coupled to at least the data aggregation and analysis component. The plurality of data sources include information related to a natural resource site including one or more of: a particular production level of natural resource site, an operational capability of the natural resource site, a result of a previous test related to exploration of a particular natural resource, or an identity of the natural resource site. The data aggregation and analysis component is coupled to at least a communication link and includes an interface to receive data or information from one or more of: a client device, a requesting device, or the plurality of data sources. The identification engine is coupled to at least the interface to receive an identity of an individual or entity and to authenticate the identity, and to receive a request from the natural resource site. The filter engine is coupled to at least the plurality of data sources and the non-transitory computer readable storage to receive information regarding weather, natural disasters, financial data related to natural resources, global political events, or legal data sources. The filter engine is further capable of filtering the information obtained from the plurality of data sources to reduce the information obtained from the plurality of data sources based on at least the identity and a type of the request. The decision engine is coupled to the filter engine to receive a reduced set of information from the filter engine and to produce a customized data set. The customized data set is changeable in response to real-time changes in the information obtained from the plurality of data sources, and the customized data set facilitates exploration, management or monitoring of natural resources at the natural resource site.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

What is claimed is:

1. A system that facilitates exploration and management of natural sources, the system comprising:
a data aggregation and analysis component implemented at least partially using electronic circuits, and comprising an identification engine, a filter engine, a decision engine and a non-transitory computer readable storage; and
a plurality of data sources coupled to at least the data aggregation and analysis component, wherein
the plurality of data sources include information related to a natural resource site including one or more of: a particular production level of natural resource site, an operational capability of the natural resource site, a result of a previous test related to exploration of a particular natural resource, or an identity of the natural resource site,
the data aggregation and analysis component is coupled to at least a communication link and includes an interface to receive data or information from one or more of: a client device, a requesting device, or the plurality of data sources,
the identification engine is coupled to at least the interface to receive an identity of an individual or an entity and to authenticate the identity, and to receive a request from the natural resource site,
the filter engine is coupled to at least the plurality of data sources and the non-transitory computer readable storage to receive information regarding weather, natural disasters, financial data related to natural resources, global political events, or legal data sources, the filter engine further filtering the information obtained from the plurality of data sources to reduce the information obtained from the plurality of data sources based on at least the identity of the natural resource site and a type of the request, and
the decision engine is coupled to the filter engine to receive a reduced set of information from the filter engine and to produce a customized data set, wherein the customized data set is changeable in response to real-time changes in the information obtained from the plurality of data sources, and wherein the customized data set facilitates exploration, management or monitoring of natural resources at the natural resource site.

2. The system of claim 1, wherein at least one of the data sources includes information related to a geographic location that is different from the geographic location of the natural resource site.

3. The system of claim 2, wherein the geographic location that is different from the geographic location of the natural resource site is located in a different continent than the geographic location of the natural resource site.

4. The system of claim 1, wherein the customized data set includes information related to a pending or a recently-occurred natural disaster that is likely to affect exploration, management or monitoring of natural resources at the natural resource site.

5. The device of claim 1, wherein the customized data set includes information related to a pending or a recently-occurred political or social event that is likely to affect exploration, management or monitoring of natural resources at the natural resource site.

6. The device of claim 1, wherein the customized data set includes information related to a legal event that is likely to affect exploration, management or monitoring of natural resources at the natural resource site.

7. The device of claim 6, wherein the legal event is one or more of: a conclusion of a legal court proceeding related to a natural resource, a treaty related to a natural resource, a law related to a natural resource, or a regulation related to an environmental regulation of a natural resource.

8. The device of claim 1, wherein the customized data set includes information related to a price fluctuation of a natural resource.

9. The device of claim 1, wherein the customized data set includes information related to an operational capability at the natural resource site.

10. The device of claim 1, wherein the natural resource site is an oil or a natural gas site.

11. The device of claim 1, wherein the request includes one or more of the following: an inquiry regarding a likelihood of finding additional oil at a particular site, or an inquiry regarding a likelihood of requiring an increased production of oil in a particular future interval of time.

12. A method, comprising:
receiving information related to a natural resource site, the information comprising one or more of: a particular production level of natural resource site, an operational capability of the natural resource site, a result of a previous test related to exploration of a particular natural resource, or an identity of the natural resource site, the received information further comprising a request from the natural resource site;
obtaining information from a plurality of data sources comprising one or more of: weather, natural disasters, financial data related to natural resources, global political events, or legal data sources;
filtering the information obtained from the plurality of data sources to reduce the information obtained from the plurality of data sources based on at least the identity of the natural resource site and a type of the request to produce a customized data set, the filtering carried out by a filtering engine that is implemented using a processor and a non-transitory memory that includes processor executable code, wherein the processor-executable code when executed by the processor causes the filtering engine to filter the information obtained from the plurality of data sources; and
producing a customized data set based on the reduced information, the customized data set being changeable in response to real-time changes in the information obtained from the plurality of data sources, and wherein the customized data set facilitates exploration, management or monitoring of natural resources at the natural resource site.

13. The method of claim 12, wherein at least one of the data sources includes information related to a geographic location that is different from the geographic location of the natural resource site.

14. The method of claim 13, wherein the geographic location that is different from the geographic location of the natural resource site is located in a different continent than the geographic location of the natural resource site.

15. The method of claim 12, wherein the customized data set includes information related to a pending or a recently-occurred natural disaster that is likely to affect exploration, management or monitoring of natural resources at the natural resource site.

16. The method of claim 12, wherein the customized data set includes information related to a pending or a recently-occurred political or social event that is likely to affect exploration, management or monitoring of natural resources at the natural resource site.

17. The method of claim 12, wherein the customized data set includes information related to a legal event that is likely to affect exploration, management or monitoring of natural resources at the natural resource site.

18. The method of claim 17, wherein the legal event is one or more of: a conclusion of a legal court proceeding related to a natural resource, a treaty related to a natural resource, a law related to a natural resource, or a regulation related to an environmental regulation of a natural resource.

19. The method of claim 12, wherein the customized data set includes information related to a price fluctuation of a natural resource.

20. The method of claim 12, wherein the customized data set includes information related to an operational capability at the natural resource site.

21. The method of claim 12, wherein the natural resource site is an oil or a natural gas site.

22. The method of claim 12, wherein the request includes one or more of the following: an inquiry regarding a likelihood of finding additional oil at a particular site, or an inquiry regarding a likelihood of requiring an increased production of oil in a particular future interval of time.

23. A computer program product, embodied on one or more non-transitory computer readable media, comprising:
program code for receiving information related to a natural resource site, the information comprising one or more of: a particular production level of natural resource site, an operational capability of the natural resource site, a result of a previous test related to exploration of a particular natural resource, or an identity of the natural resource site, the received information further comprising a request from the natural resource site;
program code for obtaining information from a plurality of data sources comprising one or more of: weather, natural disasters, financial data related to natural resources, global political events, or legal data sources;
program code for filtering the information obtained from the plurality of data sources to reduce the information obtained from the plurality of data sources based on at least the identity of the natural resource site and a type of the request to produce a customized data set; and
program code for producing a customized data set based on the reduced information, the customized data set being changeable in response to real-time changes in the information obtained from the plurality of data sources, and wherein the customized data set facilitates exploration, management or monitoring of natural resources at the natural resource site.
